(19) United States
(12) Patent Application Publication
(10) Pub. No.: US 2017/0121481 A1
(43) Pub. Date: May 4, 2017

(54) RESIN FOAM, FOAM MEMBER, AND DEVICE WITH TOUCH SCREEN

(71) Applicant: NITTO DENKO CORPORATION, Ibaraki-shi, Osaka (JP)

(72) Inventors: Itsuhiro HATANAKA, Ibaraki-shi, Osaka (JP); Tetsuya OTSUKA, Ibaraki-shi, Osaka (JP); Yusuke YAMANARI, Ibaraki-shi, Osaka (JP); Hiroyuki SUZUKI, Ibaraki-shi, Osaka (JP); Kazumichi KATO, Ibaraki-shi, Osaka (JP); Kohei DOI, Ibaraki-shi, Osaka (JP)

(73) Assignee: NITTO DENKO CORPORATION, Ibaraki-shi, Osaka (JP)

(21) Appl. No.: 15/128,623

(22) PCT Filed: Mar. 12, 2015
(86) PCT No.: PCT/JP2015/058150

§ 371 Date: Sep. 23, 2016

(30) Foreign Application Priority Data
Mar. 26, 2014 (JP) 2014-064660
Feb. 9, 2015 (JP) 2015-023513

(51) Int. Cl. C08J 9/12; G06F 3/041; B32B 5/20; B32B 7/12; C08J 9/00; C09J 7/02

(52) U.S. Cl. CPC C08J 9/122; C08J 9/0066; C08J 9/0061; C09J 7/0289; C09J 7/0246; B32B 5/20; B32B 7/12; G06F 3/041; C08J 2203/08; C08J 2205/044; C08J 2323/12; C08J 2423/08; C08J 2201/032; C08J 2333/20; C08J 2433/08; C08J 2205/05; C09J 2201/606; C09J 2433/006; C09J 2423/046; C09J 2423/106; C08J 2201/03; C08J 2203/06; B32B 2323/10; B32B 2457/208

(57) ABSTRACT

Provided is a resin foam (13) that highly restrains the occurrence of display irregularities in a display unit when the resin foam is used in a touch-screen-equipped device (1), where the display irregularities may occur with user's touch operations. The resin foam (13) according to the present invention is obtained by expansion of a resin composition including a resin. The resin foam has a 25% compression load of 0.1 N/cm² to 8.0 N/cm² and is used in the touch-screen-equipped device (1). The resin is preferably at least one resin selected from the group consisting of polyolefin resins, polyester resins, and acrylic resins.

### TECHNICAL FIELD

The present invention relates to resin foams, foam members, and devices equipped with touch screens (touch-screen-equipped devices). Specifically, the present invention relates to a specific resin foam, a foam member including the resin foam, and a touch-screen-equipped device including the resin foam. The resin foam, when used in the touch-screen-equipped device, highly restrains the occurrence of display irregularities in a display unit, where the display irregularities may occur with user's touch operations.

### BACKGROUND ART

Touch-screen-equipped devices and products including the touch-screen-equipped devices have been widely used, where the touch-screen-equipped devices are each equipped with a touch screen (touch panel; touch-sensitive screen). The touch-screen-equipped devices require to be protected from external factors such as shocks (impacts) in order to eliminate or minimize the occurrence of breakdowns and defective operations.

For example, there has been proposed the use of shock absorbers (cushioning materials) in cellular phones and other portable terminals (see Patent Literature (PTL) 1 and PTL 2). Typically, assume that a portable terminal falls involuntarily and receives a high impact. Even in this case, the use of the shock absorber can lessen the impact to the display panel and effectively eliminates or minimizes breakage, cracking, and other significant damages on the display panel.

### CITATION LIST

### Patent Literature

PTL 1: Japanese Unexamined Patent Application Publication (JP-A) No. 2011-205539

PTL 2: JP-A No. 2014-17718

### SUMMARY OF INVENTION

### Technical Problem

With the proliferation of touch-screen-equipped devices such as smartphones and portable terminals, there are increasing occasions for users to touch or push the screen with one or more fingers and/or with a jig (stylus) such as a stylus pen. These touch-screen-equipped devices are more and more slimed in thickness, and members or components to constitute the devices are more and more slimed in thickness. Non-limiting examples of the members include display panels represented by LCD panels; and touch screens, which detect the position of touching. Such slimed display panels and touch screens become extremely susceptible to deflection (sagging) when the user pushes the screen. Sagging, when occurring in a display panel, causes the display panel to interfere with another member (e.g., a circuit board or a battery) and to suffer from display irregularities (concentric image distortion). The display irregularities occur probably because the sagging may cause the display panel to be pushed against another member inside the device and to receive stress, and the stress may disturb the orientations of liquid crystal molecules.

There have been proposed some techniques as possible solutions to the display irregularities (concentric image distortion), which may occur by the stress applied on the display panel. Examples of the techniques include a technique of providing a gap around a display panel to allow the display panel to less receive stress even when the display panel is deformed; a technique of designing a display panel and a touch screen to have a larger thickness to thereby resist sagging; and a technique of allowing the cabinet of a touch-screen-equipped device to have larger stiffness to thereby resist deformation. These techniques, however, cause disadvantageous effects of increased thickness and/or increased weight of the resulting touch-screen-equipped devices.

Under these circumstances, touch-screen-equipped devices require significant reduction in thickness more and more and still require a solution to the display irregularities (concentric image distortion), which may occur upon stress application on the display panel.

Accordingly, the present invention has an object to provide a resin foam that highly restrains the occurrence of display irregularities in a display unit, where the display irregularities may occur with user's touch operations when the resin foam is used in a touch-screen-equipped device.

In addition, the present invention has another object to provide a touch-screen-equipped device that highly resists the occurrence of display irregularities in a display unit, where the display irregularities may occurs with user's touch operations.

### Solution to Problem

After intensive investigations under these circumstances, the inventors of the present invention found a resin foam having a specific 25% compression load; and found that the resin foam, when used in a touch-screen-equipped device, can highly restrain the occurrence of display irregularities in a display unit, where the display irregularities may occur with user's touch operations, even when the touch-screen-equipped device is thin. The present invention has been made based on these findings.

Specifically, the present invention provides, in an embodiment, a resin foam obtained by expanding a resin composition including a resin. The resin foam has a 25% compression load of 0.1N/cm² to 8.0 N/cm². The resin foam is to be used in a touch-screen-equipped device.

The resin is preferably at least one resin selected from the group consisting of polyolefin resins, polyester resins, and acrylic resins.

The resin foam is preferably obtained by expansion via the steps of impregnating the resin composition with a high-pressure gas and decompressing the impregnated resin composition.

The resin foam is preferably obtained by expansion via the steps of molding the resin composition into an unfoamed molded article, impregnating the unfoamed molded article with the high-pressure gas, and decompressing the impregnated unfoamed molded article.

The resin foam is preferably obtained by expansion via the steps of melting the resin composition, impregnating the molten resin composition with the high-pressure gas, and decompressing the impregnated resin composition.

The resin foam is preferably obtained further by heating after the step of impregnating and the step of decompressing.

The gas is preferably an inert gas.

The gas is preferably carbon dioxide gas.

The gas is preferably in a supercritical state.

The present invention also provides, in another embodiment, a foam member including the resin foam.

The foam member preferably further includes a pressure-sensitive adhesive layer on or over the resin foam.

The present invention, in yet another embodiment, a touch-screen-equipped device including the resin foam, a display panel, and a touch screen. The resin foam is disposed in space behind the rear face of the display panel.

The resin foam in the touch-screen-equipped device preferably has a thickness of 50% to 300% of the height of the space.

The resin foam in the touch-screen-equipped device preferably has an area of a side facing the rear face of the display panel of 20% or more relative to the area of the rear face of the display panel.

In addition and advantageously, the present invention provides a method for eliminating or minimizing the occurrence of concentric image distortion in a display panel in a touch screen product, where the touch screen product includes the display panel and a touch screen. The method includes disposing the resin foam in space behind the rear face of the display panel to eliminate or minimize the concentric image distortion in the display panel upon user's touch operations.

### Advantageous Effects of Invention

The resin foam according to the present invention, when used in a touch-screen-equipped device, can highly restrain the occurrence of display irregularities in a display unit, where the display irregularities may occur with user's touch operations.

The touch-screen-equipped device according to the present invention includes the resin foam and can highly resist the occurrence of display irregularities in a display panel, where the display irregularities may occur with user's touch operations.

### BRIEF DESCRIPTION OF DRAWINGS

FIG. 1 is a schematic exploded perspective view of a touch-screen-equipped device according to an embodiment;

FIG. 2 is a schematic outside perspective view of the touch-screen-equipped device according to the embodiment;

FIG. 3 is a schematic cross-sectional view of the touch-screen-equipped device according to the embodiment;

FIG. 4 is a schematic top view of a relaxation tester;

FIG. 5 is a schematic cross-sectional view of the relaxation tester;

FIG. 6 depicts an image of pressure acting on the pressure-sensitive paper (impact paper) in the display irregularities determination test in Example 1:

FIG. 7 depicts an image of pressure acting on the pressure-sensitive paper in the display irregularities determination test in Example 2;

FIG. 8 depicts an image of pressure acting on the pressure-sensitive paper in the display irregularities determination test in Example 3;

FIG. 9 depicts an image of pressure acting on the pressure-sensitive paper in the display irregularities determination test in Example 4;

FIG. 10 depicts an image of pressure acting on a pressure-sensitive paper in the display irregularities determination test in Example 5;

FIG. 11 depicts an image of pressure acting on the pressure-sensitive paper in the display irregularities determination test in Example 6;

FIG. 12 depicts an image of pressure acting on the pressure-sensitive paper in the display irregularities determination test in Example 7;

FIG. 13 depicts an image of pressure acting on the pressure-sensitive paper in the display irregularities determination test in Comparative Example 1;

FIG. 14 depicts an image of pressure acting on the pressure-sensitive paper in the display irregularities determination test in Comparative Example 2;

FIG. 15 illustrates an exemplary line that is drawn so as to quantitatively determine the pressure in a pressure image obtained in the display irregularities determination test;

FIG. 16 is a graph quantitatively illustrating the pressure distributions in the pressure images obtained in the display irregularities determination tests in Examples 1 to 4;

FIG. 17 is a graph quantitatively illustrating the pressure distributions in the pressure images obtained in the display irregularities determination tests in Examples 5 to 7; and

FIG. 18 is a graph quantitatively illustrating the pressure distributions in the pressure images obtained in the display irregularities determination tests in Comparative Examples 1 and 2.

### DESCRIPTION OF EMBODIMENTS

### Resin Foam

The resin foam according to the present invention is derived from a resin composition including a resin via expansion of the resin composition. The resin foam has a 25% compression load of 0.1 N/cm² to 8.0 N/cm² and is used in a touch-screen-equipped device. The resin foam according to the present invention has a cell structure (foam structure).

The resin foam according to the present invention is obtained by expanding the resin composition. The resin composition refers to a composition containing a resin to constitute the resin foam. The resin composition may contain the resin in a content not limited, but preferably 30 weight percent or more, more preferably 50 weight percent or more, and furthermore preferably 80 weight percent or more, based on the total amount (the total weight, 100 weight percent) of the resin composition.

The resin foam according to the present invention has a 25% compression load of 0.1 N/cm² or more, preferably 0.2 N/cm² or more, and more preferably 0.5 N/cm² or more. The term “25% compression load” refers to a repulsive stress for 25% compression. The resin foam according to the present invention, as having a 25% compression load (repulsive stress for 25% compression) of 0.1 N/cm² or more, gains sufficient resistivity against compression (force to press back against the compression) to disperse the force. This effectively reduces force acting on the display panel, where the force causes display irregularities.

The resin foam according to the present invention has a 25% compression load (repulsive stress for 25% compression) of 8.0 N/cm² or less, preferably 6.0 N/cm² or less, more preferably 3.0 N/cm² or less, and furthermore preferably 2.0 N/cm² or less. The resin foam according to the present invention, as having a 25% compression load (repulsive stress for 25% compression) of 8.0 N/cm² or less, has appropriate flexibility and restrains the propagation of force to an adjacent article, where the propagation often occurs when the resin foam is hard. This effectively reduces force acting on the display panel, where the force causes display irregularities.

In particular, the resin foam according to the present invention preferably has a 25% compression load of 2.0 N/cm² or less. This is preferred so as to restrain the occurrence of display irregularities and to still offer excellent stress relaxation properties. The resin foam according to the present invention, when having a compression load of 2.0 N/cm² or less, can have high stress relaxation ability per unit volume and can highly restrain the occurrence of display irregularities, even when the resin foam has a small thickness and/or a small surface area.

As used herein, the term “25% compression load” refers to a value determined in the following manner. A sheet-like resin foam is compressed in the thickness direction to a height (thickness) of 25% of the initial thickness, held in that state for 10 seconds, and the repulsive force after holding is measured at an ambient temperature of 23° C. (degree Celsius), the measured repulsive force is converted into a value per unit area, and this is defined as the 25% compression load.

The resin foam according to the present invention may have a density (apparent density) not limited, but preferably 0.020 g/cm³ or more, more preferably 0.025 g/cm³ or more, furthermore preferably 0.030 g/cm³ or more, and still more preferably 0.035 g/cm³ or more. The resin foam according to the present invention, when having a density of 0.020 g/cm³ or more, tends to readily have sufficient strength and to offer good handleability. The resin foam according to the present invention may have a density not limited, but preferably 0.48 g/cm³ or less, more preferably 0.40 g/cm³ or less, furthermore preferably 0.20 g/cm³ or less, and still more preferably 0.15 g/cm³ or less. The resin foam according to the present invention, when having a density of 0.48 g/cm³ or less, may resist being hard (rigid) upon deformation and effectively restrain the occurrence of display irregularities. The density at the level or less is also preferred for the resin foam to have a lower 25% compression load.

The cell structure of the resin foam according to the present invention is not limited and may be any of closed-cell structures, open-cell structures (interconnecting cell structures), and semi-open semi-closed cell structures. The semi-open semi-closed cell structures are each a cell structure including both a closed-cell structure and an open-cell structure. In the point of flexibility, the resin foam according to the present invention preferably has any of semi-open semi-closed cell structures, of which a semi-open semi-closed cell structure containing the closed-cell structure moiety in a content of 40% or less (more preferably 30% or less) is more preferred.

The resin foam according to the present invention may have an average cell size (average cell diameter in the cell structure) not limited, but preferably 10 μm or more, and more preferably 20 μm or more. The resin foam according to the present invention, when having an average cell size of 10 μm or more, may more readily offer good flexibility and good impact absorption and more effectively restrain the occurrence of display irregularities. The resin foam may have an average cell size of preferably 200 μm or less, and more preferably 150 μm or less. The resin foam according to the present invention, when having an average cell size of 200 μm or less, may more readily offer good seaming ability and good dust-proofness. The average cell size may be determined typically by taking an enlarged image of the cell structure moiety in a transverse section using a digital microscope, determining the areas of cells (bubbles), and converting the measured areas into equivalent circle diameters.

The resin foam according to the present invention may have an expansion ratio not limited, but preferably 1.5 to 40, and more preferably 2 to 30. This is preferred for the resin foam to offer good flexibility and good impact absorption, to effectively restrain the occurrence of display irregularities, and to have a lower 25% compression load. The expansion ratio may be determined by dividing the density before expansion by the density after expansion.

The resin foam according to the present invention may have a thickness not limited, but preferably 0.05 mm or more, more preferably 0.07 mm or more, and furthermore preferably 0.08 mm or more. The resin foam according to the present invention, when having a thickness of 0.05 mm or more, may reduce the force acting on the display panel and effectively restrain the occurrence of display irregularities, even when a component such as the display panel and/or the touch screen undergoes sagging. The resin foam according to the present invention may have a thickness of preferably 2.0 mm or less, more preferably 1.0 mm or less, furthermore preferably 0.7 mm or less, and still more preferably 0.4 mm or less. This is preferred for supporting reduction in thickness of the touch-screen-equipped device.

The resin foam according to the present invention may have a shape not limited, but preferably has a shape of sheet or tape. The resin foam may also be processed into an appropriate shape according to the intended use. For example, the resin foam may be processed into a linear, circular, polygonal, picture-frame (frame), or any other shapes typically by cutting or blanking (dicing). Further, the resin foam may be subjected typically to slicing, beating/compressing with a hot roller, or any other processing so as to have a desired thickness.

The resin to constitute the resin foam according to the present invention is not limited, but preferably selected from thermoplastic resins. Non-limiting examples of the thermoplastic resins include polyolefin resins, styrenic resins, polyamide resins, polyamideimides, polyurethanes, polyimides, polyetherimides, acrylic resins, poly(vinyl chloride)s, poly(vinyl fluoride)s, alkenyl aromatic resins, polyester resins, polycarbonates, polyacetals, and poly(phenylene sulfide)s. Each of different resins may be used alone or in combination. The resin, when being a copolymer, may be any of random copolymers and block copolymers.

The thermoplastic resins also include “at least one selected from rubber components and thermoplastic elastomer components”. Non-limiting examples of the “at least one selected from rubber components and thermoplastic elastomer components” include natural or synthetic rubbers such as natural rubbers, polyisobutylenes, polyisoprenes, chloroprene rubbers, isobutylene-isoprene rubbers, and nitrile-isobutylene-isoprene rubbers; olefinic elastomers; styrenic elastomers such as styrene-butadiene-styrene copolymers, styrene-isoprene-styrene copolymers, and hydrogenated derivatives of them; polyester elastomers; polyamide elastomers; polyurethane elastomers; acrylic elastomers; and any other thermoplastic elastomers.

The resin to constitute the resin foam according to the present invention may contain (a) “one or more thermoplastic resins excluding the rubber components and the thermoplastic elastomer components” alone; or (b) both “one or more thermoplastic resins excluding rubber components and thermoplastic elastomer components” and “at least one selected from rubber components and thermoplastic elastomer components”; or (c) “at least one selected from rubber components and thermoplastic elastomer components” alone.

The resin to constitute the resin foam according to the present invention, when including “at least one selected from rubber components and thermoplastic elastomer components”, allows the resin foam to more readily have excellent flexibility and excellent shape conformability. This configuration is also preferred for a lower 25% compression load of the resin foam.

Assume that the resin to constitute the resin foam according to the present invention contains (b) both “one or more thermoplastic resins excluding rubber components and thermoplastic elastomer components” and “at least one selected from rubber components and thermoplastic elastomer components”. In this case, the ratio of the “one or more thermoplastic resins excluding rubber components and thermoplastic elastomer components” to the “at least one selected from rubber components and thermoplastic elastomer components” is not limited, but preferably from 10:90 to 90:10, and more preferably from 80:20 to 20:80. This is preferred for the resin foam to offer satisfactory cushioning properties and to have a cell structure with a high expansion ratio.

The resin to constitute the resin foam according to the present invention is preferably at least one resin selected from the group consisting of polyolefin resins, polyester resins, and acrylic resins. This is preferred for easy control of the glass transition temperature (Tg) and for development of flexibility of the resin foam at room temperature. Specifically, the resin foam according to the present invention is preferably derived from, via expansion, a resin composition including at least one resin selected from the group consisting of polyolefin resins, polyester resins, and acrylic resins.

Non-limiting examples of the polyolefin resins include low-density polyethylenes, medium-density polyethylenes, high-density polyethylenes, linear low-density polyethylenes, polypropylenes, copolymers of ethylene and propylene, copolymers of ethylene or propylene with another α-olefin (e.g., butene-1, pentene-1, hexene-1, or 4-methylpentene-1), and copolymers of ethylene and another ethylenically unsaturated monomer (e.g., vinyl acetate, acrylic acid, an acrylic ester, methacrylic acid, a methacrylic ester, or vinyl alcohol). Non-limiting examples of the polyolefin resins also include olefinic elastomers such as ethylene-propylene copolymers, ethylene-propylene-diene copolymers, ethylene-vinyl acetate copolymers, polybutenes, and chlorinated polyethylenes. The resin may include each of different polyolefin resins alone or in combination.

The olefinic elastomers generally have a structure in which an olefinic resin and an olefinic rubber component are in microphase separation from each other. The olefinic resin is exemplified by polyethylenes and polypropylenes. The olefinic rubber component is exemplified by ethylene-propylene rubbers and ethylene-propylene-diene rubbers. The olefinic elastomers may each be one obtained by physical dispersion of the components, or one obtained by subjecting the components to a heat treatment dynamically in the presence of a crosslinking agent. The olefinic elastomers offer good compatibility.

Non-limiting examples of the polyester resins include poly(alkylene terephthalate) resins such as poly(ethylene terephthalate)s, poly(trimethylene terephthalate)s, poly(butylene terephthalate)s, poly(ethylene naphthalate)s, poly(butylene naphthalate)s, and poly(cyclohexane terephthalate)s; and copolymers obtained by copolymerizing two or more of the polyalkylene terephthalate resins. Each of the poly(alkylene terephthalate) resins, when being a copolymer, may be any of random copolymers, block copolymers, and graft copolymers. Non-limiting examples of the polyester resins also include polyester elastomers. The resin may include each of different polyester resins alone or in combination.

The polyester elastomers are not limited, as long as being elastomer resins each having an ester bond moiety formed by the reaction (polycondensation) between a polyol component and a polycarboxylic acid component. Such polyester elastomers are exemplified by polyester elastomer resins obtained by polycondensation of an aromatic dicarboxylic acid (divalent aromatic carboxylic acid) and a diol component.

Non-limiting examples of the aromatic dicarboxylic acid include terephthalic acid, isophthalic acid, phthalic acid, naphthalenedicarboxylic acids (e.g., 2,6-naphthalenedicarboxylic acid and 1,4-naphthalenedicarboxylic acid), diphenyl ether dicarboxylic acids, and 4,4′-biphenyldicarboxylic acid. Each of different aromatic dicarboxylic acids may be used alone or in combination.

Non-limiting examples of the diol component include aliphatic diols such as ethylene glycol, propylene glycol, trimethylene glycol, 1,4-butanediol (tetramethylene glycol), 2-methyl-1,3-propanediol, 1,5-pentanediol, 2,2-dimethyl-1,3-propanediol (neopentyl glycol), 1,6-hexanediol, 3-methyl-1,5-pentanediol, 2-methyl-2,4-pentanediol, 1,7-heptanediol, 2,2-diethyl-1,3-propanediol, 2-methyl-2-propyl-1,3-propanediol, 2-methyl-1,6-hexanediol, 1,8-octanediol, 2-butyl-2-ethyl-1,3-propanediol, 1,3,5-trimethyl-1,3-pentanediol, 1,9-nonanediol, 2,4-diethyl-1,5-pentanediol, 2-methyl-1,8-octanediol, 1,10-decanediol, 2-methyl-1,9-nonanediol, 1,18-octadecanediol, and dimer diols; alicyclic diols such as 1,4-cyclohexanediol, 1,3-cyclohexanediol, 1,2-cyclohexanediol, 1,4-cyclohexanedimethanol, 1,3-cyclohexanedimethanol, and 1,2-cyclohexanedimethanol; aromatic diols such as bisphenol-A, ethylene oxide adducts of bisphenol-A, bisphenol-S, ethylene oxide adducts of bisphenol-S, xylylenediols, and naphthalenediols; ether glycols such as diethylene glycol, triethylene glycol, tetraethylene glycol, poly(ethylene glycol)s, and dipropylene glycol; and any other diol components. The diol component may also be selected from diol components in the form of polymers, such as polyether diols and polyester diols. Non-limiting examples of the polyether diols include poly(ethylene glycol)s, poly(propylene glycol)s, and poly(tetramethylene glycol)s, each prepared typically by ring-opening polymerization respectively of ethylene oxide, propylene oxide, and tetrahydrofuran; copolyethers prepared by copolymerization of these components; and any other polyether diols. Each of different diol components may be used alone or in combination.

Non-limiting examples of the polyester elastomers also include polyester elastomers, which are block copolymers of a hard segment and a soft segment. In particular, the polyester elastomers are preferably the polyester elastomers, which are block copolymers of a hard segment and a soft segment and have both elasticity and flexibility.

Non-limiting examples of the polyester elastomers (polyester elastomers as block copolymers of a hard segment and a soft segment) as mentioned above include polyester-polyester copolymers (i), polyester-polyether copolymers (ii), and polyester-polyester copolymers (iii). The polyester-polyester copolymers (i) each include a hard segment and a soft segment. The hard segment includes a polyester formed by polycondensation between any of the aromatic dicarboxylic acids and a diol component, where the diol component is, of the above-mentioned diol components, one containing 2 to 4 carbon atoms in the principal chain between the two hydroxyl groups. The soft segment includes a polyester formed by polycondensation between any of the aromatic dicarboxylic acids and a diol component, where this diol component is, of the diol components, one containing 5 or more carbon atoms in the principal chain between the two hydroxyl groups. The polyester-polyether copolymers (ii) each include a hard segment and a soft segment, where the hard segment includes the polyester as in the copolymers (i), and the soft segment includes a polyether such as the polyether diols. The polyester-polyester copolymers (iii) each include a hard segment and a soft segment, where the hard segment includes the polyester as in the copolymers (i) and (ii), and the soft segment includes an aliphatic polyester.

Assume that the resin to constitute the resin foam according to the present invention contains a polyester elastomer. In particular in this case, the polyester elastomer to constitute the resin foam is preferably selected from polyester elastomers which are block copolymers of a hard segment and a soft segment, and is more preferably selected from the polyester-polyether copolymers (ii). The polyester-polyether copolymers (ii) are polyester-polyether copolymers each including a hard segment and a soft segment. The hard segment includes a polyester, and the soft segment includes a polyether, where the polyester is formed by polycondensation between the aromatic dicarboxylic acid and a diol component, where the diol component is one containing 2 to 4 carbon atoms in the principal chain between the two hydroxyl groups. More specifically, non-limiting examples of the polyester-polyether copolymers (ii) include polyester-polyether block copolymers each including a poly(butylene terephthalate) as the hard segment, and a polyether as the soft segment.

Examples of the acrylic resins include, but are not limited to, poly(methyl methacrylate)s and other acrylic resins (acrylic resins excluding acrylic elastomers); and acrylic elastomers. The resin to constitute the resin foam may include each of different acrylic resins alone or in combination.

The acrylic resins are preferably selected from acrylic resins derived from monomer components essentially including a first monomer that gives a homopolymer having a glass transition temperature Tg of −10° C. or higher, and a second monomer that gives a homopolymer having a glass transition temperature Tg of lower than −10° C. The resin, when employing the acrylic resin as mentioned above with appropriately adjusted proportions in amounts of the first monomer and the second monomer, can relatively easily give a resin foam that has excellent flexibility and impact absorption at room temperature.

As used herein, the phrase “monomer that gives a homopolymer having a glass transition temperature Tg of XXX” refers to that “the homopolymer of the monomer has a glass transition temperature Tg of XXX”, and is also simply referred to as “monomer having a homopolymer Tg of XXX”. Specifically, values of the homopolymer Tg can be found typically in “Polymer Handbook” (Third Edition, John Wiley & Sons, Inc., 1987). The glass transition temperature Tg of a homopolymer of a monomer not found in the literature may be defined as a value determined typically by the following measurement method (see JP-A No. 2007-51271). Specifically, 100 parts by weight of the monomer, 0.2 part by weight of 2,2′-azobisisobutyronitrile, and 200 parts by weight of ethyl acetate as a polymerization solvent are charged into a reactor equipped with a thermometer, a stirrer, a nitrogen inlet tube, and a reflux condenser, followed by stirring for one hour with introduction of nitrogen gas. After purging of oxygen from the reaction system in this manner, the temperature is raised up to 63° C., followed by a reaction for 10 hours. Next, the resulting mixture is cooled down to room temperature and yields a homopolymer solution having a solids concentration of 33 weight percent. Next, the homopolymer solution is applied onto a release film by flow casting, is dried, and yields a test sample (sheet-like homopolymer) having a thickness of about 2 mm. The test sample is blanked into a disc having a diameter of 7.9 mm, and the disc-shaped sample is held between parallel plates. The viscoelasticity of the sample is measured using a rheometer (ARES, supplied by Rheometrics) in a shear mode in the temperature range of −70° C. to 150° C. at a rate of temperature rise of 5° C./min while applying a shear strain at a frequency of 1 Hz. The determined peak top temperature of tan 6 is defined as the glass transition temperature Tg of the homopolymer (homopolymer Tg). The glass transition temperature Tg of the resin (polymer) may also be measured by this method.

The monomer having a homopolymer Tg of −10° C. or higher may have a homopolymer Tg of typically −10° C. to 250° C., preferably 10° C. to 230° C., and furthermore preferably 50° C. to 200° C.

Non-limiting examples of the monomer having a homopolymer Tg of −10° C. or higher include (meth)acrylonitrile; amido-containing monomers such as (meth)acrylamide and N-hydroxyethyl(meth)acrylamide; (meth)acrylic acid; (meth)acrylic alkyl esters having a homopolymer Tg of −10° C. or higher, such as methyl methacrylate and ethyl methacrylate; isobornyl (meth)acrylate; heterocycle-containing vinyl monomers such as N-vinyl-2-pyrrolidone; and hydroxy-containing monomers such as 2-hydroxyethyl methacrylate. Each of different monomers may be used alone or in combination. Among them, (meth)acrylonitriles are preferred, of which acrylonitrile is particularly preferred. The use of (meth)acrylonitriles (in particular, acrylonitrile) as the monomer having a homopolymer Tg of −10° C. or higher allows the resin foam to have higher strength, probably because of strong intermolecular interaction.

The monomer having a homopolymer Tg of lower than −10° C. may have a homopolymer Tg of typically from −70° C. to lower than −10° C., preferably −70° C. to −12° C., and furthermore preferably −65° C. to −15° C.

Non-limiting examples of the monomer having a homopolymer Tg of lower than −10° C. include (meth)acrylic alkyl esters having a homopolymer Tg of lower than −10° C., such as ethyl acrylate, butyl acrylate, and 2-ethylhexyl acrylate. Each of these monomers may be used alone or in combination. Among them, acrylic C₂-C₈ alkyl esters are preferred.

The content of the monomer having a homopolymer Tg of-10° C. or higher is typically 2 to 30 weight percent of all monomer components (the total amount of monomer components) to form the acrylic resin. Of the content, the lower limit is preferably 3 weight percent, and more preferably 4 weight percent; and the upper limit is preferably 25 weight percent, and more preferably 20 weight percent. The content of the monomer having a homopolymer Tg of lower than −10° C. is typically 70 to 98 weight percent of all monomer components (the total amount of monomer components) to form the acrylic resin. Of the content, the lower limit is preferably 75 weight percent, and more preferably 80 weight percent; and the upper limit is preferably 97 weight percent, and more preferably 96 weight percent.

Monomers to form the acrylic resin, when including a nitrogen-containing copolymerizable monomer, can give a resin foam having excellent foaming properties. This is because as follows. Assume that the monomers are formulated into an emulsion resin composition, and the emulsion resin composition is foamed (expanded) by applying shear to the composition typically via mechanical stirring. In this process, the composition offers a lower viscosity to more readily include many bubbles into the emulsion to give a bubble-containing emulsion resin composition. The bubble-containing emulsion resin composition, when applied onto a substrate and dried as being left stand, more readily undergoes agglutination to have a higher viscosity. This allows the bubbles to remain in the composition and to resist diffusion to the outside.

Non-limiting examples of the nitrogen-containing copolymerizable monomer (nitrogen-containing monomer) include cyano-containing monomers such as (meth)acrylonitrile; lactam-ring-containing monomers such as N-vinyl-2-pyrrolidone; and amido-containing monomers such as (meth)acrylamide, N-hydroxyethyl(meth)acrylamide, N-methylolacrylamide, N,N-dimethylacrylamide, N,N-diethylacrylamide, and diacetoneacrylamide. Among them, preferred are cyano-containing monomers such as acrylonitrile; and lactam-ring-containing monomers such as N-vinyl-2-pyrrolidone. Each of different nitrogen-containing monomers may be used alone or in combination.

When the acrylic resin is one derived from monomer components including a nitrogen-containing monomer, the content of the nitrogen-containing monomer is preferably 2 to 30 weight percent of all monomer components (the total amount of monomer components) to form the acrylic resin. Of the content, the lower limit is more preferably 3 weight percent, and furthermore preferably 4 weight percent; and the upper limit is more preferably 25 weight percent, and furthermore preferably 20 weight percent.

In the acrylic resin derived from monomer components including the nitrogen-containing monomer as mentioned above, the monomer components preferably further include an acrylic C₂-C₁₈ alkyl ester (in particular, an acrylic C₂-C₈ alkyl ester) in addition to the nitrogen-containing monomer. The monomer components may include each of different acrylic C₂-C₁₈ alkyl esters alone or in combination. The content of the acrylic C₂-C₁₈ alkyl ester (in particular, the acrylic C₂-C₈ alkyl ester) is preferably 70 to 98 weight percent of all the monomer components (the total amount of monomer components) to form the acrylic resin of the above type. Of the content, the lower limit is more preferably 75 weight percent, and furthermore preferably 80 weight percent; and the upper limit is more preferably 97 weight percent, and furthermore preferably 96 weight percent.

Examples of the styrenic resins include, but are not limited to, polystyrenes; acrylonitrile-butadiene-styrene copolymers (ABS resins); as well as styrenic elastomers such as styrene-butadiene-styrene copolymers, styrene-isoprene-styrene copolymers, and hydrogenated derivatives of them.

The resin to constitute the resin foam may include each of different styrenic resins alone or in combination.

Non-limiting examples of the polyamide resins include 6-nylon, 66-nylon, and 12-nylon; as well as polyamide elastomers. The resin to constitute the resin foam may include each of different polyamide resins alone or in combination.

Non-limiting examples of the polycarbonates include bisphenol-A polycarbonates. The resin to constitute the resin foam may include each of different polycarbonates alone or in combination.

The resin foam according to the present invention is obtained by expansion of the resin composition including the resin. The resin composition may further include one or more additives as needed, in addition to the resin. The resin composition may include each of different additives alone or in combination.

The resin composition preferably includes powder particles as a foam-nucleating agent. This is preferred so as to allow the resin foam to have a cell structure in a good expansion state with a high expansion ratio and to have a lower 25% compression load.

Non-limiting examples of the powder particles include talc, silica, alumina, zeolite, calcium carbonate, magnesium carbonate, barium sulfate, zinc oxide, titanium oxide, aluminum hydroxide, magnesium hydroxide, mica, montmorillonite and other clay, carbon particles, glass fibers, and carbon tubes. The resin composition may include each of different types of powder particles alone or in combination.

The powder particles may have an average particle diameter not limited, but preferably 0.1 to 20 μm. This is preferred because as follows. The powder particles, when having an average particle diameter of 0.1 μm or more, may sufficiently offer the functions as the foam-nucleating agent. The powder particles, when having an average particle diameter of 20 μm or less, may effectively restrain the occurrence of outgassing upon expansion.

The amount of the powder particles in the resin composition is not limited, but preferably 0.1 part by weight or more, more preferably 1 part by weight or more, and furthermore preferably 2 parts by weight or more, per 100 parts by weight of the resin. The resin composition, when containing the powder particles in an amount of 0.1 part by weight or more, may more readily give a homogeneous foam. The amount of the powder particles is preferably 150 parts by weight or less, more preferably 130 parts by weight or less, and furthermore preferably 50 parts by weight or less, per 100 parts by weight of the resin. This is preferred because as follows. The resin composition, when containing the powder particles in an amount of 150 parts by weight or less, may less suffer from remarkable increase in viscosity and may less cause disadvantageous outgassing upon expansion forming, where the outgassing may impair foaming properties.

The resin foam according to the present invention is for use in a touch-screen-equipped device and may require flame retardancy (fire resistance). Accordingly, the resin composition used to form the resin foam according to the present invention may include a flame retardant. The flame retardant is not limited, but is preferably selected typically from inorganic flame retardants. The resin composition may include each of different flame retardants alone or in combination.

The inorganic flame retardants are not limited and may be selected from bromine-containing flame retardants, chlorine-containing flame retardants, phosphorus-containing flame retardants, and antimony-containing flame retardants. Disadvantageously, however, the chlorine-containing flame retardants and the bromine-containing flame retardants may evolve gas components that are harmful to the human body and corrosive on equipment and facilities; and the phosphorus-containing flame retardants and the antimony-containing flame retardants may be harmful and/or explosive. Accordingly, the inorganic flame retardants are more preferably selected typically from non-halogen-non-antimony inorganic flame retardants. Non-limiting examples of the non-halogen-non-antimony inorganic flame retardants include hydrated metallic compounds such as aluminum hydroxide, magnesium hydroxide, hydrates of magnesium oxide-nickel oxide, and hydrates of magnesium oxide-zinc oxide. The hydrated metallic compounds may have undergone surface treatment.

The amount of the flame retardant in the resin composition is not limited, but preferably 5 parts by weight or more, more preferably 7 parts by weight or more, and furthermore preferably 10 parts by weight or more, per 100 parts by weight of the resin. This is preferred for offering sufficient flame retardant effects. The amount of the flame retardant is preferably 130 parts by weight or less, and more preferably 120 parts by weight or less, per 100 parts by weight of the resin. This is preferred for giving a resin foam with a high expansion ratio.

The resin composition to form the resin foam according to the present invention may further include one or more additives as needed, within ranges not adversely affecting the advantageous effects of the present invention. In addition to the above-mentioned additive(s), non-limiting examples of the additives include plasticizers, lubricants, colorants (e.g., pigments and dyestuffs), ultraviolet absorbers, antioxidants, age inhibitors, fillers, reinforcers, antistatic agents, surfactants, tension modifiers, shrinkage inhibitors, flowability improvers, vulcanizers, and surface-treatment agents.

The resin composition may be prepared by any method not limited, but may be prepared typically by kneading the resin and the additives used as needed. The kneading may be performed with heating. The resin composition upon use may typically be a resin solution of the resin in a solvent; or an emulsion containing the resin (emulsion resin composition). When the resin to constitute the resin foam according to the present invention is an acrylic resin, the resin composition to be used is preferably an emulsion containing the resin. This is preferred from the viewpoint of foaming properties. The resin composition may be a blend of two or more different emulsions. The emulsion(s) preferably has a higher solids concentration from the viewpoint of film-formability. Specifically, the emulsion may have a solids concentration of preferably 30 weight percent or more, more preferably 40 weight percent or more, and furthermore preferably 50 weight percent or more.

The resin composition may have a melt flow rate (MFR) at 190° C. of not limited, but preferably 5 to 50 g/10 min, and more preferably 7 to 40 g/10 min. This is preferred for allowing the resin composition to readily have satisfactory formability and allowing the resin foam to have a uniform cell structure. As used herein the term “MFR at 190° C.” refers to a melt flow rate (MFR) measured according to ISO 1133 (JIS K 7210) at a temperature of 190° C. and a load of 21.6 kgf.

The resin foam according to the present invention is obtained by expansion (foaming) of the resin composition. The technique to expand the resin composition is not limited.

Exemplary techniques to expand the resin composition include physical expansion techniques and chemical expansion techniques. The physical expansion techniques are expansion techniques via dispersion of bubbles by physical procedures. The chemical expansion techniques are expansion techniques via chemical procedures. Assume that the expansion is performed according to such a physical expansion technique using a blowing agent. In this case, disadvantageously, there is concern on combustibility, toxicity, and environmental impact (such as ozone layer depletion) of a material used as the blowing agent (blowing-agent gas). Also assume that the expansion is performed according to such a chemical expansion technique using a blowing gas. In this case, disadvantageously, the residue of the blowing gas remains in the foam; this may cause troubles such as, in the case of the blowing agent being corrosive, corrosion by the corrosive gas, and contamination by impurities in the gas; and these troubles may be significant especially in applications where contamination should be essentially minimized. In addition, the physical and chemical expansion techniques are believed to be difficult to give a fine cell structure and to be very difficult to give fine bubbles (micro cells) of 300 μm or less.

In particular, the resin foam according to the present invention is preferably obtained by a method for expansion via the steps of impregnating the resin composition with a high-pressure gas (gas at high pressure); and decompressing the impregnated resin composition (releasing the impregnated resin composition from the pressure). This method enables easy formation of a fine cell structure in the resin foam.

The gas (gas as a blowing agent) for use herein is preferably an inert gas. The inert gas is preferred from the viewpoints of combustibility, toxicity, environmental impact, and easiness to give a clean foam that is approximately devoid of impurities and other unnecessary components. The “inert gas” refers to a gas that is inert to the resin composition, with which the resin composition can be impregnated. Non-limiting examples of the inert gas include carbon dioxide gas (carbonic acid gas), nitrogen gas, helium, and air. The gas may be a mixture of two or more different gases. Among them, carbon dioxide gas is preferred, because the resin composition can be impregnated with carbon dioxide in a large amount at a high impregnation rate.

The gas (e.g., the inert gas, in particular, carbon dioxide gas) is preferably in a supercritical state for higher impregnation rate of the resin composition with the gas. The gas, when in a supercritical state, may have better solubility in the resin composition and can thereby be incorporated into the resin composition in a higher concentration. In addition, because of its high concentration, the gas in a supercritical state generates a larger number of cell nuclei upon an abrupt pressure drop (decompression) after impregnation. These cell nuclei grow to give cells that are present in a higher density than in a resin foam having the same porosity and prepared with the same gas but in another state. This gives fine bubbles (fine micro cells). Carbon dioxide has a critical temperature and a critical pressure of 31° C. and 7.4 MPa, respectively.

The resin foam according to the present invention is preferably obtained by a method for expansion via the steps of impregnating the resin composition with a high-pressure gas, and decompressing the impregnated resin composition, as described above. This method may employ a batch system or a continuous system. According to the batch system, the resin composition is previously formed (shaped) into an appropriate shape such as a sheet shape as an unfoamed resin molded article (unfoamed molded article); the unfoamed resin molded article is impregnated with the high-pressure gas; and the impregnated molded article is released from the pressure to expand the molded article. According to the continuous system, molding and expansion are performed simultaneously, in which the resin composition is kneaded and molded with the high-pressure gas under pressure (under a load), and simultaneously with the kneading/molding, the resin composition is released from the pressure.

Assume that the resin foam according to the present invention is produced according to the batch system. This production will be illustrated below. In the production of the resin foam according to the batch system, first, an unfoamed resin molded article is prepared. Exemplary techniques for preparing the unfoamed resin molded article include, but are not limited to, a technique of molding the resin composition using an extruder such as a single-screw extruder or a twin-screw extruder; a technique of uniformly kneading the resin composition in a kneading machine equipped with one or more blades typically of roller, cam, kneader, or Banbury type, and press-forming the kneaded article to a predetermined thickness typically using a hot-plate press machine; and a technique of molding the resin composition using an injection molding machine. The preparation technique is preferably selected appropriately from these techniques so as to obtain an unfoamed resin molded article having desired dimensions such as shape and thickness. The unfoamed resin molded article may also be prepared by another technique (process) than the extrusion molding, the press forming, and the injection molding. The shape of the unfoamed resin molded article is not limited to the sheet shape, but may be selected from various shapes according to the intended use. Non-limiting examples of the shape include shapes of a sheet, a roller, a rectangular column, and a plate. Next, bubbles (foams) are formed via a gas impregnation step, a decompression step, and in some cases as needed, a heating step. In the gas impregnation step, the unfoamed resin molded article (molded article of the resin composition) is placed in a pressure-tight vessel, into which the high-pressure gas is injected (introduced) to impregnate the unfoamed resin molded article with the high-pressure gas. In the decompression step, the molded article is released from the pressure (generally, down to the atmospheric pressure) at the time point when the molded article is sufficiently impregnated with the high-pressure gas, to form cell nuclei in the unfoamed resin molded article. In the heating step, the molded article is heated to allow the cell nuclei in the molded article to grow. Alternatively, the cell nuclei may be allowed to grow at room temperature without providing the heating step. After cell growth in the above manner, the article is rapidly cooled typically with cold water according to necessity to fix its shape, and yields the resin foam. The high-pressure gas may be introduced continuously or discontinuously. The heating to allow the cell nuclei to grow may be performed according to a known or common procedure typically using a water bath, oil bath, hot roller, hot-air oven, far-infrared rays, near-infrared rays, or microwaves.

In other words, in an embodiment, the resin foam according to the present invention may be obtained via the steps of molding the resin composition to give an unfoamed molded article, impregnating the unfoamed molded article with a high-pressure gas, and decompressing the resulting article to expand the article. In another embodiment, the resin foam may be obtained via the steps of molding the resin composition to give an unfoamed molded article, impregnating the unfoamed molded article with a high-pressure gas, decompressing the resulting article, and further heating the article after decompression.

In contrast, according to the continuous system, the resin foam may be produced typically by a method including a kneading-impregnation step and a molding-decompression step. In the kneading-impregnation step, the resin composition is kneaded in an extruder such as a single-screw extruder or a twin-screw extruder and, during the kneading, a high-pressure gas is injected (introduced) into the resin composition to impregnate the resin composition with the gas sufficiently. In the molding-decompression step, the resin composition is extruded typically through a die provided at the nose of the extruder to release the resin composition from the pressure (in general, down to the atmospheric pressure). Thus, molding and expansion are performed simultaneously in this step. The method may further include a heating step according to circumstances (according to necessity). In the heating step, the article is heated to allow cells to grow. After cell growth in the above manner, the article is rapidly cooled typically with cold water as needed to fix its shape, and yields the resin foam. The kneading-impregnation step and the molding-decompression step may also employ an injection molding machine or another molding machine than the extruder.

In other words, the resin foam according to the present invention may also be obtained by expansion via the steps of melting the resin composition, impregnating the molten resin composition with a high-pressure gas, and decompressing the resulting article (impregnated molten resin composition). In another embodiment, the resin foam according to the present invention may be obtained via the steps of melting the resin composition, impregnating the molten resin composition with a high-pressure gas, decompressing the impregnated molten resin composition, and further heating the resulting article after decompression.

The amount of the gas to be incorporated into the resin composition in the gas impregnation step according to the batch system or in the kneading-impregnation step according to the continuous system is not limited, but typically preferably 1 to 10 weight percent, and more preferably 2 to 8 weight percent, relative to the total amount of the resin composition.

The pressure of the gas upon impregnation of the unfoamed resin molded article or the resin composition with the gas is preferably 3 MPa or more (e.g., 3 to 100 MPa), and more preferably 4 MPa or more (e.g., 4 to 100 MPa) in the gas impregnation step according to the batch system or in the kneading-impregnation step according to the continuous system. If the gas pressure is lower than 3 MPa, considerable cell growth may occur during expansion, and resulting cells may have excessively large cell diameters. This may often cause disadvantages such as reduction in sealing effects and dust-proofing effects, thus being undesirable. The reasons for this are as follows. When impregnation is performed under such a low pressure, the amount of the incorporated gas is relatively small, and the cell nuclei grow at a lower rate as compared with impregnation under a high pressure. As a result, cell nuclei are formed in a smaller number. Because of this, the gas amount per each cell increases rather than decreases, resulting in extremely large cell diameters. In addition, at a pressure in a region lower than 3 MPa, merely a slight change in the impregnation pressure results in considerable changes in cell diameter and cell density, and this may often impede the control of cell diameter and cell density.

The temperature upon impregnation of the unfoamed resin molded article or the resin composition with the high-pressure gas in the gas impregnation step according to the batch system or in the kneading-impregnation step according to the continuous system may be selected within a wide range, but is preferably 10° C. to 350° C. in consideration typically of operability. For example, assume that a sheet-like unfoamed resin molded article is impregnated with the high-pressure gas according to the batch system. In this case, the impregnation may be performed at a temperature of preferably 40° C. to 300° C., and more preferably 100° C. to 250° C. Also assume that the high-pressure gas is injected into the resin composition during kneading. This process may be performed at a temperature of preferably 150° C. to 300° C., and more preferably 210° C. to 250° C. When carbon dioxide is used as the high-pressure gas, the temperature upon impregnation (impregnation temperature) is preferably 32° C. or higher (in particular, 40° C. or higher) so as to retain the supercritical state.

The decompression rate in the decompression step is not limited, but is preferably 5 to 300 MPa/s so as to give fine, uniform cells. The heating temperature in the heating step is not limited, but is preferably 40° C. to 250° C., and more preferably 60° C. to 250° C.

The resin foam production method can produce a resin foam with a high expansion ratio and can allow the resin foam to have a large thickness. For example, assume that a resin foam is to be obtained according to the continuous system. In this case, the die provided at the nose of the extruder requires a gap as narrow as possible (in general, 0.1 to 1.0 mm) so as to retain the pressure inside the extruder in the kneading-impregnation step. Accordingly, the resin composition extruded through such a narrow gap is to be expanded with a high expansion ratio so as to give a thick resin foam. Conventional techniques, however, fail to give such a high expansion ratio, and the resulting foam is restricted in small thickness (e.g., 0.5 to 2.0 mm). In contrast, the resin foam production method using the high-pressure gas can continuously give resin foams each having a final thickness of 0.30 to 5.00 mm.

The resin foam according to the present invention may also be obtained by a method for preparing a foam via the step (step A) of mechanically foaming (expanding) the emulsion resin composition. A foaming apparatus for use herein is not limited and may be selected from apparatuses typically of a high-speed shearing system, a vibration system, or a pressurized gas discharging system. Among them, apparatuses of the high-speed shearing system are preferred from the viewpoints of reduction in cell diameter and of large-scale production.

The cells (bubbles) formed by mechanical stirring include a gas incorporated into the emulsion. The gas is not limited, as long as being inert to the emulsion, and is exemplified by air, nitrogen, and carbon dioxide. Among them, air is preferred from the viewpoint of economic efficiency.

The resin foam according to the present invention may be obtained via the step (step B) of applying the foamed emulsion resin composition onto a substrate and drying the applied composition, where the foamed emulsion resin composition is obtained via the step A. Non-limiting examples of the substrate include release-treated plastic films such as release-treated poly(ethylene terephthalate) films; plastic films such as poly(ethylene terephthalate) films; and thermally-conductive layers. Assume that such a thermally-conductive layer is used as the substrate on which the expanded emulsion resin composition is applied. In this case, the resulting foam layer may offer better adhesion to the substrate, i.e., to the thermally-conductive layer, and the drying step to prepare the foam layer can be performed more efficiently.

The application (coating) and the drying in the step B may be performed by common techniques. The step B preferably includes a preliminary drying step B1 and a drying step B2. In the preliminary drying step B1, the foamed emulsion resin composition applied onto the substrate is dried at a temperature of from 50° C. to lower than 125° C. In the drying step B2, the preliminarily dried composition is further dried at a temperature of 125° C. to 200° C.

Providing of the preliminary drying step B1 and the drying step B2 may eliminate or minimize coalescence and rupture of the cells due to abrupt temperature rise. In particular, the providing of the preliminary drying step B1 is of great significance in a resin foam having a small thickness. This is because such a thin resin foam may be susceptible to coalescence and/or rupture of cells due to the abrupt temperature rise. The preliminary drying step B1 may be performed at a temperature of preferably from 50° C. to 100° C. for a time (duration) of typically 0.5 minute to 30 minutes, and preferably 1 minute to 15 minutes. The drying step B2 may be performed at a temperature of preferably 130° C. to 180° C., and more preferably 130° C. to 160° C. for a time (duration) of typically 0.5 minute to 30 minutes, and preferably 1 minute to 15 minutes.

The resin foam according to the present invention has a 25% compression load of 0.1 N/cm² to 8.0 N/cm². This configuration allows the resin foam, when used in a touch-screen-equipped device, to effectively disperse and/or absorb force that is formed with sagging/deformation of the display panel and/or the touch screen, where the sagging/deformation occurs with the user's touch operations. Accordingly, the resin foam according to the present invention can highly restrain the occurrence of display irregularities (concentric image distortion) in the display unit, where the display irregularities (concentric image distortion) may occur due to the application of stress on the display panel. Thus, the resin foam according to the present invention is advantageously usable in touch-screen-equipped devices.

The resin foam is also usable typically as shock absorbers, cushioning materials, and sealants.

As used herein, the term “touch-screen-equipped device” refers to a device or apparatus that includes a display panel and is equipped with a touch screen. Non-limiting examples of the touch-screen-equipped device include cellular phones; smartphones; personal digital assistants (PDAs); tablet computers; various personal computers such as desktop, notebook, and tablet personal computers; various displays (monitors) such as plasma displays, liquid crystal displays (LCDs), and electroluminescent displays (organic electroluminescent displays); handheld game consoles; digital audio players; electronic book readers (devices for electronic book reading, dedicated terminals for electronic books); wearable computers (wearable devices); digital signage; automated teller machines (ATMs); automatic ticket vending machines and other automatic bending machines for use in selling typically of tickets, various coupons, beverages, foodstuffs, cigarettes, magazines, and newspapers; television receivers (television sets); and electronic whiteboards (interactive whiteboards).

### Foam Member

The resin foam according to the present invention may be used as or in a foam member. In other words, the foam member is a member that includes the resin foam according to the present invention. For example, the foam member may have a structure (configuration) including the resin foam according to the present invention alone; or a structure including the resin foam and another layer (in particular, a pressure-sensitive adhesive layer and/or a base layer) disposed on or over the resin foam. Further, the foam member may include a skin layer and/or a layer having a heated, molten surface.

The foam member may be in any form not limited, but is preferably in a sheet form (including a film form) or in a tape form. The foam member may have undergone processing so as to have desired dimensions such as shape and thickness. For example, the foam member may have undergone processing so as to have a shape corresponding to the touch-screen-equipped device in which the resin foam is to be used.

In particular, the foam member preferably includes a pressure-sensitive adhesive layer. For example, when the resin foam is a sheet-like resin foam (resin foam sheet), the foam member preferably includes a pressure-sensitive adhesive layer on or over at least one side of the resin foam. Assume that the foam member includes the pressure-sensitive adhesive layer. This configuration allows a processing backing to be provided through the pressure-sensitive adhesive layer over the resin foam and, in addition, enables securing or temporary securing of the resin foam in an easy and simple manner.

Non-limiting examples of the pressure-sensitive adhesive to form the pressure-sensitive adhesive layer include acrylic pressure-sensitive adhesives, rubber pressure-sensitive adhesives (e.g., natural rubber pressure-sensitive adhesives and synthetic rubber pressure-sensitive adhesives), silicone pressure-sensitive adhesives, polyester pressure-sensitive adhesives, urethane pressure-sensitive adhesives, polyamide pressure-sensitive adhesives, epoxy pressure-sensitive adhesives, vinyl alkyl ether pressure-sensitive adhesives, and fluorochemical pressure-sensitive adhesives. Each of different pressure-sensitive adhesives may be used alone or in combination. The pressure-sensitive adhesive may be selected from pressure-sensitive adhesives of various forms, such as emulsion pressure-sensitive adhesives, solvent-borne pressure-sensitive adhesives, hot-melt pressure-sensitive adhesives, oligomer pressure-sensitive adhesives, and solid pressure-sensitive adhesives. Among them, the pressure-sensitive adhesive is preferably an acrylic pressure-sensitive adhesive from the viewpoint typically of contamination control. Specifically, the foam member preferably includes the resin foam according to the present invention, and an acrylic pressure-sensitive adhesive layer on or over the resin foam.

The pressure-sensitive adhesive layer may have a thickness not limited, but preferably 2 to 100 μm, and more preferably 10 to 100 μm. The thickness of the pressure-sensitive adhesive layer is preferably minimized, because such a thin pressure-sensitive adhesive layer advantageously less suffers from the attachment of dirt or dust at the edges thereof. The pressure-sensitive adhesive layer may have either of a single-layer structure and a multilayer structure.

The pressure-sensitive adhesive layer in the foam member may be disposed over the resin foam through another layer (underlayer). Non-limiting examples of the underlayer as mentioned above include other pressure-sensitive adhesive layers, intermediate layers, under coats, and base layers (e.g., in particular, film layers and nonwoven fabric layers). The pressure-sensitive adhesive layer may be protected with a release film (separator) (e.g., a release paper or a release film).

### Touch-Screen-Equipped Device

The touch-screen-equipped device according to the present invention includes the resin foam (the resin foam according to the present invention), a display panel, and a touch screen (touch panel). The resin foam is disposed in space behind the rear face of the display panel. In the touch-screen-equipped device according to the present invention, the touch screen is disposed in space in front of the front face of the display panel, and the resin foam is disposed in space behind the rear face of the display panel. The space behind the rear face of the display panel corresponds to clearance (gap) in which the foam is placed.

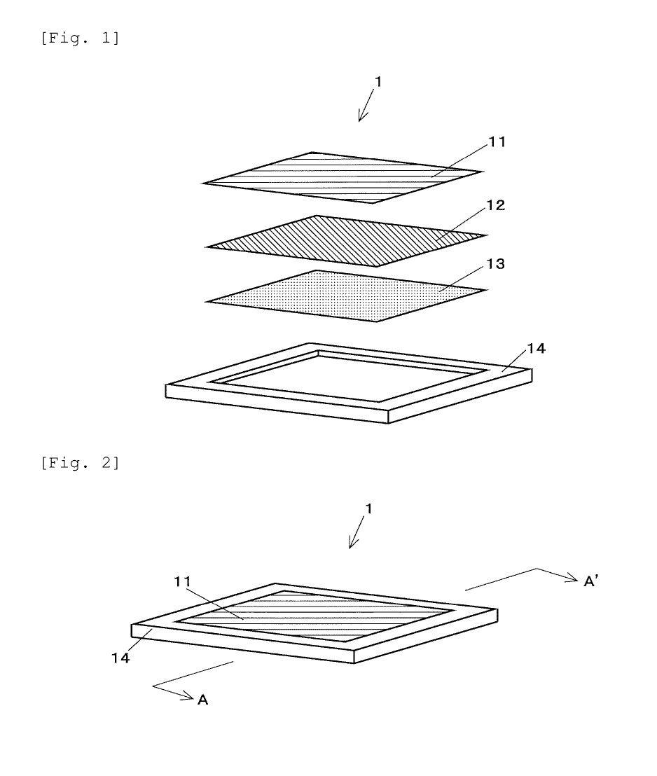

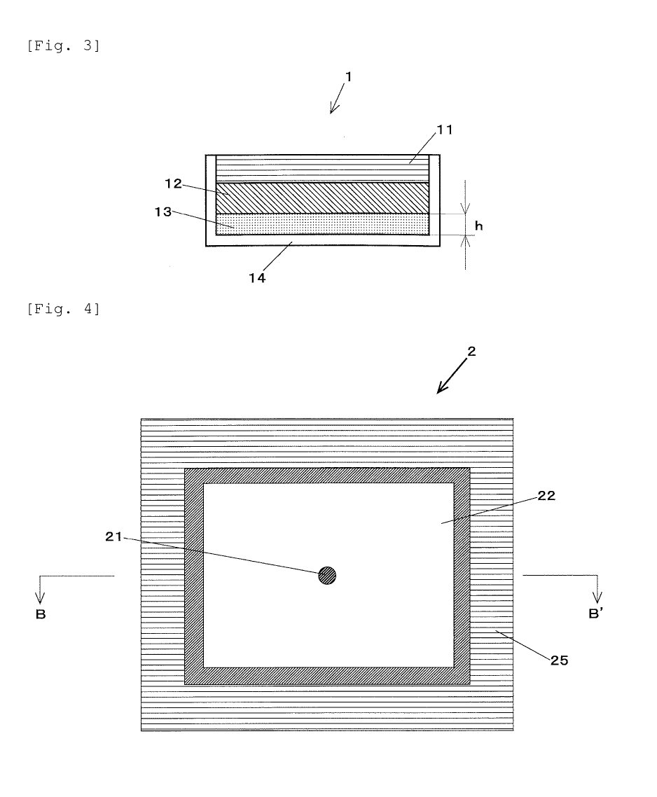

The touch-screen-equipped device according to an embodiment of the present invention will be illustrated with reference to FIGS. 1 to 3. The touch-screen-equipped device according to the present invention is not limited to the touch-screen-equipped device illustrated in FIGS. 1 to 3. FIGS. 1, 2, and 3 are a schematic exploded perspective view, a schematic outside perspective view, and a schematic cross-sectional view, respectively, of the touch-screen-equipped device according to the embodiment of the present invention. FIG. 3 is a cross-sectional view taken along the line A-A′ of FIG. 2. In FIGS. 1 to 3, the touch-screen-equipped device 1 includes a touch screen 11, a display panel 12, a resin foam 13, and a cabinet 14. The “front face” (front-side surface) in the touch-screen-equipped device illustrated in FIGS. 1 to 3 refers to a side (face) at which the user recognizes information and performs a touch operation and which is a face provided by the touch screen 11. In the touch-screen-equipped device illustrated in FIGS. 1 to 3, the touch screen 11 is disposed in space in front of the front face of the display panel 12, and the resin foam 13 is disposed in space behind the rear face of the display panel 12. The sign “h” in FIG. 3 represents the height of the space behind the rear face of the display panel 12 in the touch-screen-equipped device 1.

The touch-screen-equipped device according to the present invention may be rigid and may not undergo deformation as a whole, or may be flexible as a whole. The touch-screen-equipped device may also be partially flexible. The touch-screen-equipped device according to the present invention may have such a structure as illustrated in FIGS. 1 to 3, in which the device includes the cabinet that houses the touch screen, the display panel, and the resin foam. The touch-screen-equipped device according to the present invention may further include one or more other components or members as needed. Non-limiting examples of the other components include circuit boards, window lenses, protective glass, a variety of electronic components, batteries, a variety of optical films, and a variety of machinery parts. The touch-screen-equipped device according to the present invention may structurally include the touch screen as the entire front face or as part of the front face. The touch-screen-equipped device according to the present invention may include the touch screen at the front face alone or at both the front face and the rear face. The touch-screen-equipped device according to the present invention may include two or more touch screens.

The touch screen in the touch-screen-equipped device according to the present invention is not limited and may be selected from touch screens of any system or technology, which are exemplified by resistive touch screens, capacitive touch screens, optical imaging touch screens (touch screens using a retroreflection tape or panel), surface acoustic wave touch screens, infrared touch screens (infrared scan touch screens), and touch screens using electromagnetic induction technology. The touch screen may be of two or more systems. For example, the touch screen may include both a capacitive touch screen and a touch screen using electromagnetic induction technology.

The resin foam in the touch-screen-equipped device according to the present invention is the resin foam according to the present invention. The touch-screen-equipped device according to the present invention includes the resin foam (the resin foam according to the present invention) disposed behind the rear face of the display panel and significantly less suffers from the occurrence of display irregularities (concentric image distortion). In addition, the resin foam also acts as a shock absorber, a cushioning material, and/or a sealant.

Non-limiting examples of the display panel in the touch-screen-equipped device according to the present invention include liquid crystal displays (LCDs), organic electroluminescent displays, and plasma displays.

The display panel may further include a backlight, in addition to the panel unit. For example, the display panel, when being a liquid crystal display (LCD), may include a backlight and a liquid crystal panel (liquid crystal shutter). The display panel may also be a display module including a display drive circuit. For example, the display panel may be a liquid crystal module including both a liquid crystal display and a display drive circuit, where the liquid crystal display includes a backlight and a liquid crystal panel (liquid crystal shutter)

The resin foam in the touch-screen-equipped device according to the present invention may have any thickness not limited in relation to the height of the space behind the rear face of the display panel. However, the resin foam may have a thickness of preferably 50% or more, more preferably 75% or more, and furthermore preferably 100% or more, of the height of the space behind the rear face of the display panel. The resin foam, when having a thickness of 50% or more of the height of the space behind the rear face of the display panel, may readily disperse stress and highly restrain the occurrence of display irregularities, where the stress is generated when the touch screen is pushed or pressed upon user's touch operations. For example, assume that the touch-screen-equipped device according to the present invention structurally includes a cabinet housing the touch screen, the display panel, and the resin foam; and that the resin foam has a thickness at a predetermined level or more relative to the space behind the rear face of the display panel, where the space is a clearance in which the resin foam is placed. In this case, when the touch screen is pressed down upon user's touch operations and when the touch screen and/or the display panel sags, the sagged touch screen and/or display panel less reaches the cabinet. This restrains the sagging from causing stress acting on the display panel and highly restrains the occurrence of display irregularities caused by the stress. The resin foam may have a thickness of preferably 300% or less, more preferably 250% or less, and furthermore preferably 200% or less, of the height of the space behind the rear face of the display panel. The resin foam, when having a thickness of 300% or less of the height of the space behind the rear face of the display panel, can control the repulsive force generated upon compression of the resin foam and can more readily restrain the occurrence of display irregularities due to the repulsive force associated with the compression of the resin foam.

The resin foam in the touch-screen-equipped device according to the present invention may have an area of the face facing the rear face of the display panel of not limited, but preferably 20% or more, more preferably 50% or more, and furthermore preferably 80% or more, of the area of the rear face of the display panel. This is preferred for satisfactory impact absorption and for restrainment of the occurrence of display irregularities.

### Method

The method according to the present invention for eliminating or minimizing the occurrence of concentric image distortion in a display panel upon user's touch operations includes disposing, in a touch screen product including a display panel and a touch screen, the resin foam (the resin foam according to the present invention) in space behind the rear face of the display panel. Assume that the user's touch operations cause the display panel and/or the touch screen to sag and deform to give force. Even in this case, the resin foam, when disposed behind the rear face of the display panel, can effectively disperse and/or absorb the force and highly restrain the occurrence of display irregularities (concentric image distortion) in the display panel.

The term “touch screen product” refers to and includes, in addition to the touch-screen-equipped device, a product using or including the touch-screen-equipped device. Non-limiting examples of the touch screen product include, in addition to touch-screen-equipped devices as mentioned above, household electrical appliances each including the touch-screen-equipped device, where the household electrical appliances are exemplified by, but are not limited to, vacuum cleaners, refrigerators, air cleaners, washing machines, microwave ovens and other ovens, dish washers, air conditioners, and rice cookers; audio equipment each including the touch-screen-equipped device; car navigation systems (or electronic appliances equipped with car navigation systems) each including the touch-screen-equipped device; video cameras each including the touch-screen-equipped device; camcorders each including the touch-screen-equipped device; recorders (video recorders), players, and video players (such as DVD recorders and BD recorders) each including the touch-screen-equipped device; digital cameras each including the touch-screen-equipped device; printers each including the touch-screen-equipped device; copying machines (photocopiers) and multi-function printers (multi-function devices) each including the touch-screen-equipped device; a variety of machines and apparatuses each including the touch-screen-equipped device, where the machines and apparatuses are exemplified by, but are not limited to, analyzers, production equipment, machine tools, transport machinery, construction machinery, and agricultural implement and machinery; pachinko (Japanese pinball) machines and pachisuro machines (slot machines in pachinko parlors) each including the touch-screen-equipped device; arcade game machines each including the touch-screen-equipped device; and toys each including the touch-screen-equipped device.

### EXAMPLES

The present invention will be illustrated in further detail with reference to several examples below. It should be noted, however, that the examples are by no means intended to limit the scope of the present invention.

Resin Foam Production Example 1

Materials used herein were 55 parts by weight of a polypropylene (having a melt flow rate (MFR) of 0.25 g/10 min), 45 parts by weight of a polyolefin elastomer (having a melt flow rate (MFR) of 7 g/10 min and a JIS A hardness of 79°), 6 parts by weight of a carbon black (trade name Asahi #35, supplied by Asahi Carbon Co., Ltd.), and 10 parts by weight of magnesium hydroxide (having an average particle diameter of 0.7 μm). The materials were kneaded in a twin-screw kneader supplied by The Japan Steel Works, LTD. (JSW) at a temperature of 220° C., extruded into strands, cooled with water, and pelletized into pellets. The pellets had an apparent density of 0.98 g/cm³.

The pellets were charged into a single-screw extruder supplied by The Japan Steel Works, LTD., into which carbon dioxide gas was injected at an ambient temperature of 220° C. at a pressure of 22 MPa. The carbon dioxide gas was at a pressure of 19 MPa after injection. After sufficient saturation with the carbon dioxide gas, the resulting article was cooled down to a temperature suitable for expansion, extruded through a die, and yielded a resin foam.

This resin foam was a sheet-like resin foam having a semi-open semi-closed cell structure and had an apparent density of 0.035 g/cm³, a thickness of 2.0 mm, and an expansion ratio of 28. The resin foam had an average cell size of 55 μm.

### Example 1

The resin foam prepared in Resin Foam Production Example 1 was sliced and yielded a resin foam A having a thickness of 0.3 mm. The resin foam A had a 25% compression load of 0.80 N/cm².

### Example 2

The resin foam A was allowed to pass through between a pair of rollers (through a gap between the two rollers) and yielded a resin foam having a thickness of 0.2 mm, where one of the two rollers was heated at 200° C. The gap (clearance) between the two rollers was set so as to give a resin foam having a thickness of 0.2 mm.

Next, the resin foam having a thickness of 0.2 mm was allowed to pass through between a pair of rollers (through a gap between the two rollers) and yielded a resin foam B having a thickness of 0.1 mm. In this process, one of the two rollers was heated at 200° C. and was in contact with a side of the resin foam opposite to the side which had been in contact with the roller heated at 200° C. in the first process. The gap (clearance) between the two rollers herein was set so as to give a resin foam having a thickness of 0.1 mm.

The resin foam B had an apparent density of 0.126 g/cm³ and a 25% compression load of 1.11 N/cm².

### Example 3

This example employed a polyolefin resin foam (trade name Volara XLIM WF03, having a thickness of 0.3 mm, a 25% compression load of 5.2 N/cm², an apparent density of 0.19 g/cm³, and an average cell size of 107 μm).

### Example 4

This example employed a polyolefin resin foam (trade name Volara XLIM WF01, having a thickness of 0.1 mm, a 25% compression load of 2.8 N/cm², an apparent density of 0.31 g/cm³, and an average cell size of 63 μm).

### Example 5

Materials used herein were 100 parts by weight of an acrylic emulsion solution (having a solids content of 55 weight percent, an ethyl acrylate-butyl acrylate-acrylonitrile copolymer (in weight ratio of 45:48:7)), 2 parts by weight of a fatty acid ammonium salt surfactant (an aqueous dispersion of ammonium stearate, having a solids content of 33 weight percent) (surfactant A), 2 parts by weight of a carboxybetaine amphoteric surfactant (trade name AMOGEN CB-H, supplied by Dai-ichi Kogyo Seiyaku Co., Ltd.) (surfactant B), 0.35 part by weight of an oxazoline crosslinking agent (trade name EPOCROS WS-500, supplied by Nippon Shokubai Co., Ltd., having a solids content of 39 weight percent), and 0.78 part by weight of a poly(acrylic acid) thickener (an ethyl acrylate-acrylic acid copolymer (including 20 weight percent of acrylic-acid-derived units), having a solids content of 28.7 weight percent). The materials were mixed with stirring and foamed using a disper (trade name ROBOMIX, supplied by PRIMIX Corporation), and yielded a foamed composition. The foamed composition was applied onto a release-treated PET (poly(ethylene terephthalate)) film (having a thickness of 38 μm, trade name MRF #38, supplied by Mitsubishi Plastics, Inc.), dried at 70° C. for 4.5 minutes, further dried at 140° C. for 4.5 minutes, and yielded a resin foam having an open-cell structure. The resin foam had a thickness of 0.3 mm, an apparent density of 0.25 g/cm³, a 25% compression load of 0.47 N/cm², and an average cell size of 76 μm.

### Example 6

Materials used herein were 100 parts by weight of an acrylic emulsion solution (having a solids content of 55 weight percent, an ethyl acrylate-butyl acrylate-acrylonitrile copolymer (in weight ratio of 45:48:7)), 2 parts by weight of a fatty acid ammonium salt surfactant (an aqueous dispersion of ammonium stearate, having a solids content of 33 weight percent) (surfactant A), 2 parts by weight of a carboxybetaine amphoteric surfactant (trade name AMOGEN CB-H, supplied by Dai-ichi Kogyo Seiyaku Co., Ltd.) (surfactant B), 0.8 part by weight of an oxazoline crosslinking agent (trade name EPOCROS WS-500, supplied by Nippon Shokubai Co., Ltd., having a solids content of 39 weight percent), and 0.65 part by weight of a poly(acrylic acid) thickener (an ethyl acrylate-acrylic acid copolymer (including 20 weight percent of acrylic-acid-derived units), having a solids content of 28.7 weight percent). The materials were mixed with stirring and foamed using a disper (trade name ROBOMIX, supplied by PRIMIX Corporation), and yielded a foamed composition. The foamed composition was applied onto a release-treated PET (poly(ethylene terephthalate)) film (having a thickness of 38 μm, trade name MRF #38, supplied by Mitsubishi Plastics, Inc.), dried at 70° C. for 4.5 minutes, further dried at 140° C. for 4.5 minutes, and yielded a resin foam having an open-cell structure. The resin foam had a thickness of 0.2 mm, an apparent density of 0.28 g/cm³, a 25% compression load of 0.92 N/cm², and an average cell size of 72 μm.

### Example 7

Materials used herein were 100 parts by weight of an acrylic emulsion solution (having a solids content of 55 weight percent, an ethyl acrylate-butyl acrylate-acrylonitrile copolymer (in weight ratio of 45:48:7)), 2 parts by weight of a fatty acid ammonium salt surfactant (an aqueous dispersion of ammonium stearate, having a solids content of 33 weight percent) (surfactant A), 2 parts by weight of a carboxybetaine amphoteric surfactant (trade name AMOGEN CB-H, supplied by Dai-ichi Kogyo Seiyaku Co., Ltd.) (surfactant B), 4 parts by weight of an oxazoline crosslinking agent (trade name EPOCROS WS-500, supplied by Nippon Shokubai Co., Ltd., having a solids content of 39 weight percent), and 0.6 part by weight of a poly(acrylic acid) thickener (an ethyl acrylate-acrylic acid copolymer (including 20 weight percent of acrylic-acid-derived units), having a solids content of 28.7 weight percent). The materials were mixed with stirring and foamed using a disper (trade name ROBOMIX, supplied by PRIMIX Corporation), and yielded a foamed composition. The foamed composition was applied onto a release-treated PET (poly(ethylene terephthalate)) film (having a thickness of 38 μm, trade name MRF #38, supplied by Mitsubishi Plastics, Inc.), dried at 70° C. for 4.5 minutes, further dried at 140° C. for 4.5 minutes, and yielded a resin foam having an open-cell structure. The resin foam had a thickness of 0.1 mm, an apparent density of 0.31 g/cm³, a 25% compression load of 1.90 N/cm², and an average cell size of 57 μm.

### Comparative Example 1

A sample as a stack of two plies of a 100-μm thick poly(ethylene terephthalate) film (PET film) was used as Comparative Example 1.

### Comparative Example 2

A sample in which no article was placed in a foam-housing gap in after-mentioned display irregularities determination test and relaxation test was defined as a blank and used as Comparative Example 2.

Display Irregularities Determination Test

A commercially available smartphone was disassembled. The smartphone had space between the display panel bottom and the cabinet, and the space had a height of 0.2 mm. The space was defined as the foam-housing gap.

Next, a sample to be evaluated was placed in the foam-housing gap, and the disassembled smartphone was assembled again. In Comparative Example 2, no article was placed in the foam-housing gap.

The smartphone was activated and pushed with a thumb at the screen center part at force of about 20 N. Whether display irregularities occurred was determined and evaluated according to criteria as follows:

A: No display irregularities occurred;

B: Display irregularities occurred, but the user could visually identify information and operate the smartphone without problems; and

C: Display irregularities occurred, adversely affected the visibility, and caused the user to feel a sense of incongruity in operation of the smartphone.

Relaxation Test

A relaxation tester as follows was prepared, a sample to be evaluated was placed in the foam-housing gap, and stress relaxation properties of the sample were evaluated.

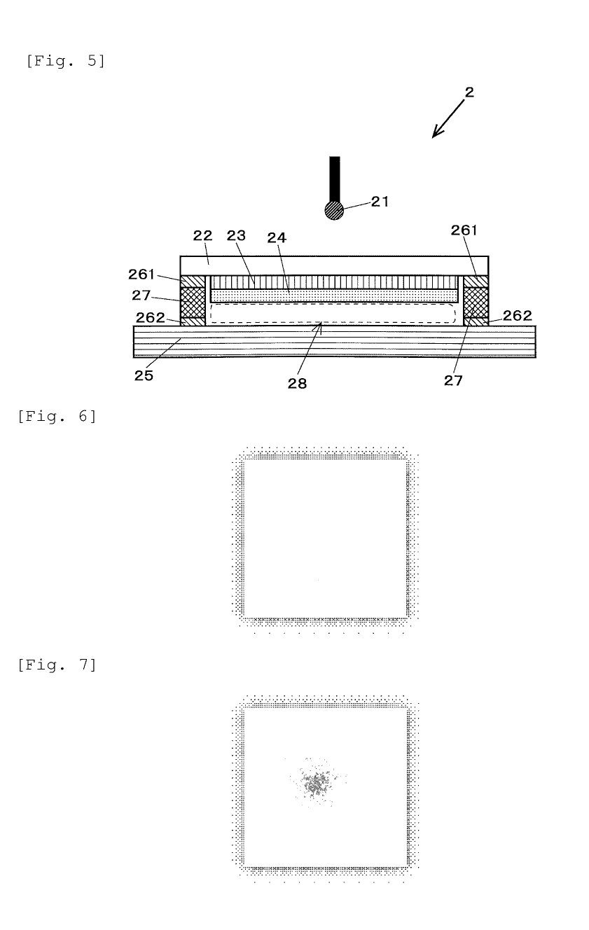

The relaxation tester is illustrated in FIGS. 4 and 5.

FIGS. 4 and 5 are a schematic top view and a schematic cross-sectional view (cross-sectional view taken along the line B-B′ of FIG. 4), respectively, of the relaxation tester. In FIGS. 4 and 5, the relaxation tester 2 includes a pusher (indenter) 21, a window lens 22, a liquid crystal display (LCD) 23, a pressure-sensitive paper 24, a substrate (base plate) 25, pressure-sensitive adhesive tapes 261 and 262, and a cabinet 27. The relaxation tester 2 has a foam-housing gap 28, which is indicated as the dotted region. The relaxation tester 2 includes the pressure-sensitive paper 24 facing the rear face of the liquid crystal display 23, and includes the window lens 22 facing the front face of the liquid crystal display 23. In the relaxation tester 2, the cabinet 27 is disposed over the substrate 25 through the pressure-sensitive adhesive tape 262, and the window lens 22 is secured via the pressure-sensitive adhesive tape 261 to the cabinet. The window lens 22, the pressure-sensitive adhesive tape 261, the pressure-sensitive adhesive tape 262, the cabinet 27, and the substrate 28 define interior space. The interior space houses an assembly of the liquid crystal display 23 and the pressure-sensitive paper 24. The interior space has the foam-housing gap 28 below the pressure-sensitive paper 24.

The window lens in the relaxation tester can be regarded as a touch screen.

The pusher 21 has a spheroidal tip having a diameter of 13 mm. The pressure-sensitive adhesive tape 261 used herein is a double-sided pressure-sensitive adhesive tape (having a thickness of 300 μm, trade name Double-Sided Pressure-Sensitive Adhesive Tape HJ-90130B, supplied by Nitto Denko Corporation). The pressure-sensitive adhesive tape 262 used herein is a double-sided pressure-sensitive adhesive tape (having a thickness of 30 μm, trade name Double-Sided Pressure-Sensitive Adhesive Tape No. 5603, supplied by Nitto Denko Corporation). The window lens 22 has a thickness of 0.8 mm. The liquid crystal display 23 has a thickness of 1.7 mm. The substrate 25 has a thickness of 5 mm. The pressure-sensitive paper 24 used herein is a stress (pressure) measurement film (trade name PRESCALE (two-sheet type, extreme low pressure (4LW), supplied by FUJIFILM Corporation, a sheet having a surface on which a color change occurs in a region receiving pressure, having a thickness of 0.16 mm).

In the relaxation tester 2, the cabinet 27 is exchangeable and can be selected from those having different heights so as to allow the foam-housing gap 28 to have a different height adjusted as appropriate.

The height of the foam-housing gap was set to 0.2 mm, and a sample to be evaluated was placed in the foam-housing gap in the relaxation tester. In the relaxation tester, a load of 20 N was applied to the central part of the touch screen using the pusher, and a color change in the pressure-sensitive paper was determined to evaluate the stress relaxation properties.

In Comparative Example 2, no article was placed in the foam-housing gap.

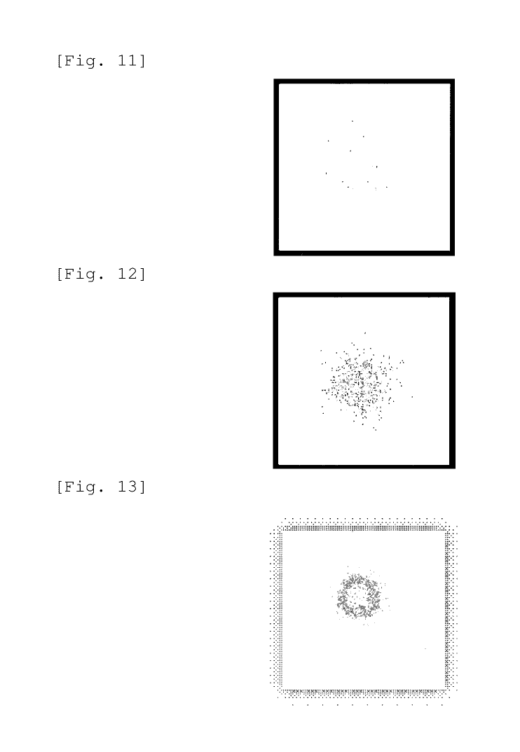

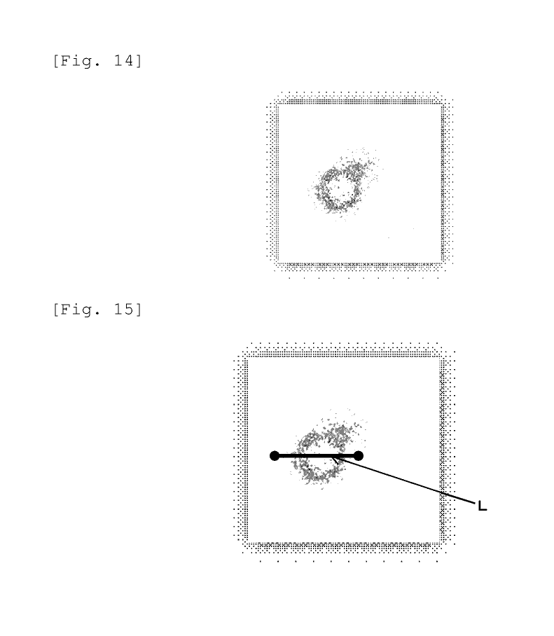

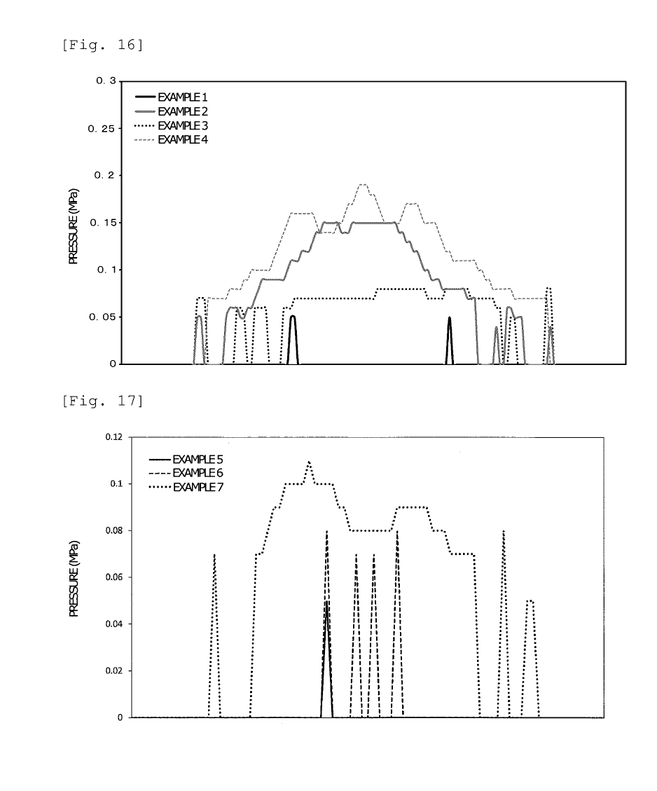

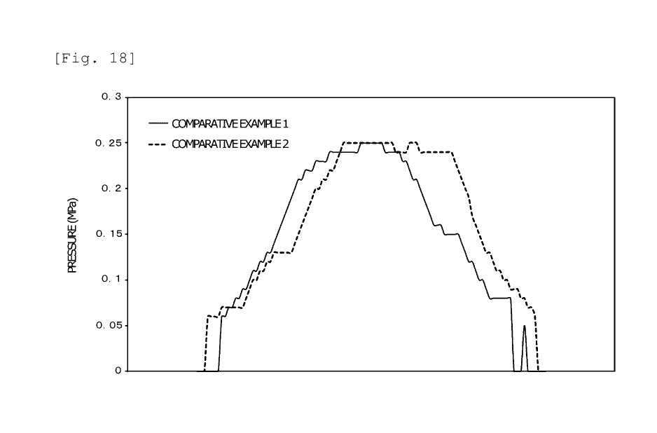

Evaluation results in the relaxation tests are given in Table 1, and FIGS. 6 to 18. FIGS. 6 to 14 illustrate pressure images according to Examples 1 to 7 and Comparative Examples 1 and 2. The pressure images were each obtained by digitally processing the color change in the pressure-sensitive paper to visualize the pressure acting on the pressure-sensitive paper. FIG. 16 is a graph illustrating pressure distributions in the pressure images of FIGS. 6 to 9. The pressure distributions were each determined by analyzing the pressure image to determine a point that received highest pressure (center, touch screen central part), drawing a line passing through the center, and plotting the pressure distribution on the line. The line corresponds to the line L in FIG. 15. FIG. 17 is a graph illustrating pressure distributions in the pressure images of FIGS. 10 to 12. The pressure distributions were each determined by analyzing the pressure image to determine a point that received highest pressure (center, touch screen central part), drawing a line passing through the center, and plotting the pressure distribution on the line. The line corresponds to the line L in FIG. 15. FIG. 18 is a graph illustrating pressure distributions in the pressure images of FIGS. 13 and 14. The pressure distributions were each determined by analyzing the pressure image to determine a point that received highest pressure (center, touch screen central part), drawing a line passing through the center, and plotting the pressure distribution on the line. The line corresponds to the line L in FIG. 15. The graphs in FIGS. 16 to 18 give quantified pressures. FIG. 15 illustrates by example how the line was drawn in the pressure image.

TABLE 1

| | Thickness | Density | 25% Compression | Display |
|---|---|---|---|---|
| | (mm) | (g/cm³) | load (N/cm²) | irregularities |
| Example 1 | 0.3 | 0.035 | 0.80 | A |
| Example 2 | 0.1 | 0.126 | 1.11 | B |
| Example 3 | 0.3 | 0.19 | 5.2 | B |
| Example 4 | 0.1 | 0.31 | 2.8 | B |
| Example 5 | 0.3 | 0.25 | 0.47 | A |
| Example 6 | 0.2 | 0.28 | 0.92 | A |
| Example 7 | 0.1 | 0.31 | 1.90 | B |
| Comparative | 0.2 | — | — | C |
| Example 1 | | | | |
| Comparative | — | — | — | C |
| Example 2 | | | | |

Comparisons between the examples and the comparative examples with reference to FIGS. 6 to 14 and 16 to 18 demonstrate that the examples received smaller pressures on the pressure-sensitive papers as compared with the comparative examples. Based on this, the examples were evaluated as having superior stress relaxation properties as compared with the comparative examples. The comparisons also demonstrate that the resin foams according to the examples, when used in touch-screen-equipped devices, can highly restrain the occurrence of display irregularities in the display unit, where the display irregularities may occur with the user's touch operations.

A comparison between Example 1 and Example 3 with reference to FIGS. 6, 8, and 16 demonstrate that Example 1 received a smaller pressure on the pressure-sensitive paper as compared with Example 3. Based on this, Example 1 was evaluated as having superior stress relaxation properties as compared with Example 3.

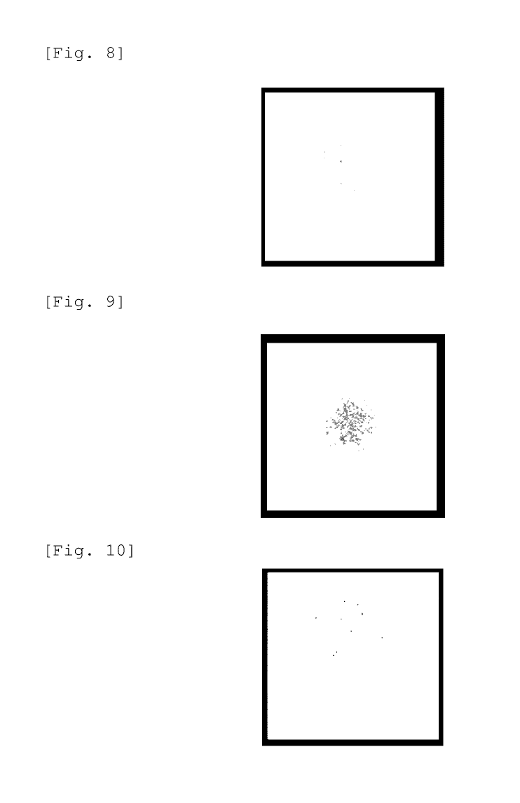

A comparison between Example 2 and Example 4 with reference to FIGS. 7, 9, and 16 demonstrate that Example 2 received a smaller pressure on the pressure-sensitive paper as compared with Example 4. Based on this, Example 2 was evaluated as having superior stress relaxation properties as compared with Example 4.

### INDUSTRIAL APPLICABILITY

The resin foam according to the present invention, when used in a touch-screen-equipped device, effectively disperses and/or absorbs force that is formed with sagging/deformation of the display panel and/or the touch screen, where the sagging/deformation occurs with the user's touch operations. Accordingly, the resin foam according to the present invention can highly restrain the occurrence of display irregularities (concentric image distortion) in the display unit, where the display irregularities may occur upon the application of stress on the display panel. The resin foam according to the present invention is therefore advantageously usable in touch-screen-equipped devices. In addition, the resin foam according to the present invention is also usable typically as or in shock absorbers, cushioning materials, and sealants.

### REFERENCE SIGNS LIST

1 touch-screen-equipped device
11 touch screen
12 display panel
13 resin foam
14 cabinet
2 relaxation tester
21 pusher
22 window lens
23 liquid crystal display
24 pressure-sensitive paper
25 substrate
261 pressure-sensitive adhesive tape
262 pressure-sensitive adhesive tape
27 cabinet
28 foam-housing gap

1. A resin foam derived from a resin composition comprising a resin,
the resin foam having a 25% compression load of 0.1 N/cm² to 8.0 N/cm²,
the resin foam being for use in a touch-screen-equipped device.

2. The resin foam according to claim 1,
wherein the resin comprises at least one resin selected from the group consisting of:
polyolefin resins;
polyester resins; and
acrylic resins.

3. The resin foam according to claim 1,
which is obtained by expansion via the steps of:
impregnating the resin composition with a high-pressure gas; and
decompressing the impregnated resin composition.

4. The resin foam according to claim 3,
which is obtained by expansion via the steps of:
molding the resin composition into an unfoamed molded article;
impregnating the unfoamed molded article with the high-pressure gas; and
decompressing the impregnated unfoamed molded article.

5. The resin foam according to claim 3,
which is obtained by expansion via the steps of:
melting the resin composition;
impregnating the molten resin composition; and
decompressing the impregnated molten resin composition.

6. The resin foam according to claim 3,
which is obtained further by heating after the step of impregnating and the step of decompressing.

7. The resin foam according to claim 3,
wherein the gas comprises an inert gas.

8. The resin foam according to claim 7,
wherein the gas comprises carbon dioxide gas.

9. The resin foam according to claim 3,
wherein the gas is in a supercritical state.

10. A foam member comprising
the resin foam according to claim 1.

11. The foam member according to claim 10, further comprising
a pressure-sensitive adhesive layer on or over the resin foam.

12. A touch-screen-equipped device comprising:
the resin foam according to claim 1;
a display panel; and
a touch screen,
the resin foam being disposed in space behind a rear face of the display panel.

13. The touch-screen-equipped device according to claim 12,
wherein the resin foam has a thickness of 50% to 300% relative to a height of the space.

14. The touch-screen-equipped device according to claim 12,
wherein the resin foam has an area of a side facing the rear face of the display panel of 20% or more relative to an area of the rear face of the display panel.

15. A method for eliminating or minimizing occurrence of concentric image distortion in a touch screen product, the touch screen product comprising a display panel and a touch screen, the method comprising
disposing the resin foam according to claim 1 in space behind a rear face of the display panel to eliminate or minimize the occurrence of concentric image distortion in the display panel upon user's touch operations.
